(19) United States
(12) Patent Application Publication
(10) Pub. No.: US 2010/0100856 A1
(43) Pub. Date: Apr. 22, 2010

(54) Automated optimization of an integrated circuit layout using cost functions associated with circuit performance characteristics

(76) Inventor: Anurag Mittal, San Jose, CA (US)

Correspondence Address: William C. Milks, III, 401Florence Street, Palo Alto, CA, 84301, US

(21) Appl. No.: 12/288,268

(22) Filed: Oct. 17, 2008

(51) Int. Cl. G06F 17/50

(52) U.S. Cl. 716/2

(57) ABSTRACT

An integrated circuit (IC) design system and method provide an optimization of a layout of an integrated circuit wherein an assessment is taken into account of the circuit performance characteristics and the layout of the IC design. The system and method assess associated circuit performance characteristics, each as a cost function of a local pattern of shapes in an initial circuit layout, aggregate cost functions of the associated circuit performance characteristics to derive an integral performance number associated to the initial global circuit layout, perturb the integral performance number by varying the global circuit layout, and select perturbations that optimize the performance number, so as to optimize the global circuit layout. Assessment is taken into account of the circuit performance characteristics based on the layout and the interdependence of the circuit performance characteristics for the IC design. The physical process related effects such as well proximity effect and stress/strain engineering and/or performance parameters such as the P-N transistor size ratio are taken into account to achieve optimization.

### BACKGROUND OF THE INVENTION

1. Field of the Invention

The present invention relates generally to a system and method for designing integrated circuits or migrating integrated circuit designs from one technology node to another for fabrication by a semiconductor manufacturing process and, more particularly, to a system and method for optimizing an integrated circuit layout. Specifically, various embodiments of the present invention provide a system and method to optimize the integrated circuit layout based on associated circuit performance characteristics.

2. Description of the Prior Art

Semiconductor designs and fabrication processes are continually evolving and the semiconductor manufacturing industry is continually developing new processes to produce smaller and smaller geometries of the designs being manufactured, because semiconductor devices typically consume less power and operate at higher speeds as they scale to smaller dimensions. Semiconductor integrated circuit (IC) design and manufacturing processes have become increasingly challenging with each new technology node. Currently, a single integrated circuit chip may contain over several billion layout patterns. Integrated circuit designs and semiconductor fabrication processes are extremely complex, since hundreds of processing steps may be involved. Occurrence of variations or lack of process control at any of the process steps may necessitate redesign or cause lower manufacturing yield, where manufacturing yield may be defined as the number of functional chips produced as compared to the theoretical number of chips that could be produced. In addition to manufacturing yield loss due to non-functional chips, the design and process steps can result in a chip that is functional but which does not meet a given specification, for example, a microprocessor that operates at 1.1 GHz, but does not operate within a specified range such as 1.3 to 1.4 GHz, which results in what is known as parametric yield loss.

In the art, the physical layout of an IC must be checked to ascertain whether the layout is acceptable for production. Generally, design-rule violations are checked (such as minimal distance or width requirements for wires) and, more recently, checking is performed whether manufacturing recommended rules are satisfied (manufacturing recommended rules will in general impose a preference for greater than minimal distances as specified by the design rules). Calculating a quality number for the layout, which quality number can be associated with a manufacturing yield prediction value, can be viewed as an advanced manner of checking the layout before production: if the quality number is unacceptably low, one may opt to modify the layout design to obtain a higher manufacturing yield prediction value.

For example, one publication that deals with calculating a manufacturing yield prediction value is U.S. Pat. No. 6,738,954. In this publication, a quality number calculation is performed on a proposed layout. A number of subdivisions of a circuit are assessed, each resulting in an average fault number and a statistical error value of said fault number. Iteratively, a statistical error of the average number is reduced until the statistical error is below an acceptable error limit.

U.S. Pat. No. 7,013,441 is another publication that is concerned with calculating a predicted manufacturing yield for an integrated circuit. Here, by selecting library elements from a design database to include in a proposed design for the integrated circuit, a yield is calculated based on a normalization factor that is associated to the library element and used to account for a susceptibility of the library element to a given defect.

These publications have in common that single quality number statements are given for pass/fail of a certain IC layout. However, the information of that quality number is not used to propose a modified design.

As described in as described in co-pending international application number PCT/NL2007/050312 filed Jun. 27, 2007 entitled METHOD FOR OPTIMIZING AN INTEGRATED CIRCUIT PHYSICAL LAYOUT assigned to the same assignee as the present application, a method of optimizing an IC layout is disclosed, wherein an initial IC layout is provided. A predetermined set of physical characteristics of a predetermined set of polygons of said initial circuit layout is assessed, and said physical characteristics are aggregated to derive an integral quality number associated with said initial circuit layout. Cost functions are generated to evaluate a perturbed quality number of said perturbed layout, and layout perturbations are selected that optimize the quality number, so that the circuit layout is optimized in an automated fashion. This pending patent application is directed to manipulating a design layout to optimize manufacturing yield. However, circuit performance characteristics of the evaluated circuit layout, and specifically circuit characteristics as influenced by device characteristics, which are a function of local layout proximity effects (examples of which will be described later), are not factored into the cost functions.

Considered in more detail, physical phenomenon, for example, well proximity effect (WPE) and stress/strain engineering associated with the fabrication of an IC, affect performance of an IC. In the present application, “stress/strain engineering” encompasses what is conventionally referred to in the art as “stress engineering,” “strain engineering,” and/or “stress/strain engineering.” Stress/strain engineering is influenced by process steps such as contact etch stop layer (CESL), dual etch stop layer (DESL), silicide, shallow trench isolation (STI) profile, number of contacts, etc., which influence the stress in the transistor channel and hence associated transistor characteristics such as mobility, on/off current, and transconductance (gₘ). The magnitude and direction of the stress due to these varied processing steps is influenced by layout geometry which can be associated with poly to poly spacing, number of poly neighbors, distance of gate to STI edge, distance of gate to well edge, number of contacts, etc. The following references describe various physical effects and the change in transistor characteristics in more detail.

1. Ricardo Borges, Victor Moroz, and Xiaopeng Xu, “Strain Engineering and Layout Context Variability at 45 nm,” Semiconductor International, Nov. 1, 2007.

2. N. Mathur Polishchuk, C. Sandstrom, P. Manos, and O. Pohland, “CMOS Vt-control improvement through implant lateral scatter elimination,” ISSM Proc., pp. 193-196, 2005.

3. M. V. Dunga, X. Xi, J. He, W. Liu, K. M. Cao, X. Jin, J. J. Ou, M. Chan, A. M. Niknejad, and C. Hu, “BSIM4.6.0 MOSFET Model,” UC Berkeley, 2006.

4. V. Moroz, X. Xu, D. Pramanik, F. Nouri, and Z. Krivokapic, “Analyzing strained-silicon options for stress-engineering transistors,” Solid State Technology, July 2004.

5. H. Fukutome, Y. Momiyama, Y. Tagawa, T. Kubo, T. Aoyama, H. Arimoto, and Y. Nara, “Direct Measurement of Effects of Shallow-Trench Isolation on Carrier Profiles in Sub-50 nm N-MOSFETs,” VLSI Technology Digest, pp. 140-141, 2005.

6. L. Washington, F. Nouri, S. Thirupapuliyur, G. Eneman, P. Verheyen, V. Moroz, L. Smith, Xiaopeng Xu, M. Kawaguchi, T. Huang, K. Ahmed, M. Balseanu, L.-Q. Xia, M. Shen, Y. Kim, R. Rooyackers, K. De Meyer, and R. Schreutelkamp, “pMOSFET With 200% Mobility Enhancement Induced by Multiple Stressors,” IEEE Electron Device Letters, Vol. 27, No. 6, pp. 511-513, 2006.

7. U.S. Pat. No. 7,329,571 Technique for providing multiple stress sources in NMOS and PMOS transistors.

8. U.S. Pat. No. 7,089,513 Integrated circuit design for signal integrity, avoiding well proximity effects.

9. U.S. Pat. No. 6,943,391 Modification of carrier mobility in a semiconductor device.

Furthermore, in view of certain physical effects, U.S. Pat. No. 7,032,194 describes layout correction algorithms for removing stress and other physical effect induced process deviation in which dimensional modifications are applied to an IC layout to compensate for performance variations caused by the physical effects. Once the layout data files have been taped out, a physical effect compensation step is performed to adjust the layout data in response to physical effect process characteristics. These characteristics are derived during a test chip step in which a test chip having a wide range of structures and configurations is produced using the final (or near-final) process. The physical effect compensation step generates a compensated IC layout that includes dimensional modifications to layout elements that are designed to counteract physical effects (such as STI stress and WPE) for a specific process. For example, current drive variations caused by STI stress can be compensated for by adjusting the gate dimensions of the affected transistors to increase or decrease current drive as necessary. However, this patent involves a test chip step associated with a specific process and actually changes the gate dimension itself, rather than modifying dimensions which influence stress in the layout. Also, U.S. Pat. No. 6,795,952 describes that MOSCAP and TESTCHIP modules contain specialty devices that measure the active sheet resistance and well and channel profiles, as well as structures to determine the yield impact of contact to poly gate spacing. However, this patent merely involves manufacturing yield prediction test vehicles.

What is needed is a system and method of specifying cost functions which account for physical phenomena associated with circuit performance characteristics of an IC design and optimizing the layout by applying the resulting cost functions in an automated fashion. Additionally, not only physical process related effects which impact circuit performance can be modeled into cost functions, circuit performance parameters which can be directly influenced by modifying layout can be modeled into cost functions, as well. For example, one can tune the P-N transistor size ratio by applying a cost function to that circuit characteristic based on changing the width of the P/N transistors as a function of desired P-N ratio and other circuit characteristics. Furthermore, several of these cost functions can be simultaneously optimized as described in co-pending international application number PCT/NL2007/050312 filed Jun. 27, 2007 entitled METHOD FOR OPTIMIZING AN INTEGRATED CIRCUIT PHYSICAL LAYOUT to achieve the desired circuit characteristics. It is to these ends that the present invention is directed. The various embodiments of the present invention provide many advantages over conventional IC design methods and systems.

### SUMMARY OF THE INVENTION

Accordingly, one object of the present invention is to provide an optimization of a layout of an integrated circuit (IC) wherein an assessment is taken into account of the circuit performance characteristics of the associated layout. The circuit performance characteristics are a function of the circuit performance parameters such as the P-N transistor size ratio, power budget, chip frequency/timing, etc. Also, circuit performance parameters for a given layout can be a function of device parameters such as mobility, I_{ON}, etc., which can be dependent on physical process related effects such as well proximity effect (WPE) and stress/strain engineering. These circuit performance parameters and/or device parameters are taken into account when manipulating the layout design to achieve optimization. Optimization of the design layout in accordance with the present invention could be aimed at circuit performance characteristics such as reducing variability, improving performance, decreasing power consumption, reducing area, increasing parametric yield, and/or tuning the speed of the IC.

According to an aspect of the present invention, there is provided a method according to claim 1. In particular, according to said aspect, there is provided a method for optimizing a global integrated circuit layout defined by a number of polygons having a predetermined geometrical relation relative to each other, comprising: providing an initial global integrated circuit layout; assessing associated circuit performance parameters and/or device parameters, each as a cost function of a local pattern of shapes in said initial circuit layout determinative of said associated circuit performance characteristics; aggregating cost functions to derive an integral performance number associated to said initial integrated circuit layout; perturbing said integral performance number by varying said global circuit layout; and selecting perturbations that optimize the integral performance number, so as to optimize said integrated circuit layout. Accordingly, a circuit performance assessment is provided, from which a modified layout design can be derived that has an improved integral performance number, in order to optimize the design in relation to a specific circuit performance assessment, such as a predicted parametric yield or reducing power or improving speed or reducing design guardband or variability.

In another aspect of the present invention, there is provided a system according to claim 19. The system comprises an input, an output, and a processor arranged to perform the method of claim 1.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing, by way of example only, to facilitate an understanding of the present invention. In the figures, like reference numerals refer to like elements. In the drawing:

FIG. 1 is a block diagram illustrating an example of an integrated circuit (IC) design system for providing circuit performance characteristic optimization in accordance with one embodiment of the present invention;

FIG. 2 illustrates well proximity effect (WPE) schematically;

FIG. 3 illustrates schematically a layout including dimensional characteristics for calculation of the effective WPE distance;

FIG. 4 shows an example cost function based on the effective WPE distance for a CMOS transistor;

FIG. 5 illustrates an example of change in PMOS or NMOS transistor mobility as a function of ploy-to-poly spacing due to stress.

FIG. 6 illustrates schematically a layout including dimensional characteristics for calculation of stress related mobility characteristic of a CMOS transistor;

FIG. 7 illustrates change in NMOS transistor current as a function of 1^{st} poly to poly spacing. The change in current is due to the stress effect as referred to in FIG. 6 and is calculated using the cost function shown in the graph;

FIG. 8 illustrates a cost function for stress related mobility of a PMOS transistor based on gate to diffusion edge spacing, and the change in current of a PMOS transistor as a function of distance from gate to diffusion edge as depicted in FIG. 6.

FIG. 9 illustrates the effect of a layout perturbation for two neighbouring squares in a layout detail;

FIG. 10 shows piecewise linearized versions of generalized cost functions.

### DETAILED DESCRIPTION OF THE PREFERRED EMBODIMENTS

The present invention is particularly applicable to a computer-implemented software-based IC design system for generating an IC design using circuit performance characteristic optimization to manipulate an IC design layout, and it is in this context that the various embodiments of the present invention will be described. It will be appreciated, however, that the IC design system and method for providing circuit performance characteristic optimization in accordance with the various embodiments of the present invention have greater utility, since they may be implemented in hardware or may incorporate other modules or functionality not described herein.

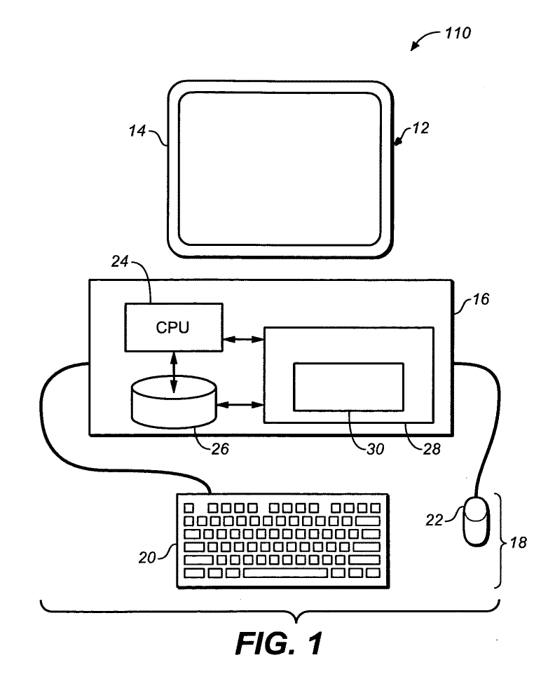

FIG. 1 is a block diagram illustrating an example of an IC design system 10 for providing circuit performance characteristic optimization in accordance with one embodiment of the present invention implemented on a personal computer 12. In particular, the personal computer 12 may include a display unit 14, which may be a cathode ray tube (CRT), a liquid crystal display, or the like; a processing unit 16; and one or more input/output devices 18 that permit a user to interact with the software application being executed by the personal computer. In the illustrated example, the input/output devices 18 may include a keyboard 20 and a mouse 22, but may also include other peripheral devices, for example, printers, scanners, and the like. The processing unit 16 may further include a central processing unit (CPU) or graphics processing unit (GPU) 24, a persistent storage device 26, such as a hard disk, a tape drive, an optical disk system, a removable disk system, or the like, and a memory 28. The CPU or GPU 24 may control the persistent storage device 26 and memory 28. Typically, a software application may be permanently stored in the persistent storage device 26 and then may be loaded into the memory 28 when the software application is to be executed by the CPU or GPU 24. In the example shown, the memory 28 may contain an IC design tool 30 for circuit performance characteristic optimization of an IC design layout. The IC design tool 30 may be implemented as one or more software modules that are executed by the CPU or GPU 24.

In accordance with the present invention, the IC design system 10 for providing circuit performance characteristic optimization of an IC design layout may also be implemented using hardware and may be implemented on different types of computer systems, such as client/server systems, Web servers, mainframe computers, workstations, and the like. Now, more details of an exemplary implementation of the IC design system 10 in software will be described.

One embodiment of the present invention provides processing of an IC design layout. For example, the IC design layout may be a GDS or OASIS file or a file having another format that comprises of corresponding design layout data.

Various embodiments of the present invention provide a method of circuit performance characteristic optimization of an IC design layout. In one embodiment of the present invention, the circuit performance characteristic optimization processor assesses circuit performance parameters and simultaneously aggregates cost functions associated to said circuit performance parameters and applies correction so as to optimize it.

Generally, cost functions can be used to model a wide variety of effects relating to manufacturing yield, as disclosed in the aforementioned co-pending international application entitled METHOD FOR OPTIMIZING AN INTEGRATED CIRCUIT PHYSICAL LAYOUT, and can be generally seen as a quality number, for instance, for predicting a printing related yield loss (e.g., attributing cost to poor contrast); random defect related yield (e.g., cost due to sensitivity to particles, or bad contacts); or mask making related cost (e.g., cost placed on jogs in shape edges because it increases mask-fracture count, and mask writer time). These all relate to manufacturing yield loss and do not factor in circuit performance parameters associated with circuit performance targets and parametric yield.

In contrast, in accordance with the various embodiments of the present invention, cost functions are:

(1) used to capture the quality number of layout associated with circuit performance characteristics;

(2) based upon device characteristics, which are function of physical effects such as WPE, stress/strain engineering, etc., and the geometric patterns of layout; and also

(3) based upon circuit performance such as P/N transistor ration, which are a function of geometrical pattern of layout.

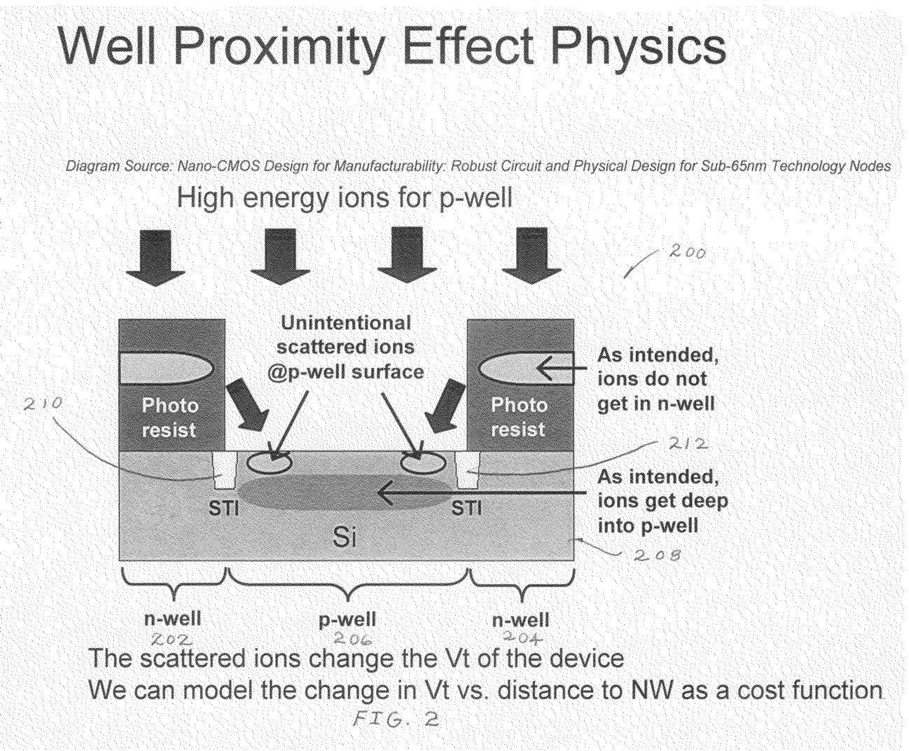

Considered in more detail, FIG. 2 illustrates WPE schematically of a transistor device 200 showing the well proximity effect that impacts circuit performance. The device 200 comprises a first N-well region 202, a second N-well region 204, and an intermediate P-well region 206 formed on a silicon substrate 208. A first shallow trench isolation (STI) region 210 is disposed between the first N-well region 202 and the P-well region 206, and a second STI region 212 is disposed between the P-well region 206 and the second N-well region 204. As shown in FIG. 2, the P-well region 206 is formed by bombarding it with high-energy ions. Photo resist applied to the surface of the silicon substrate 208 is intended to prevent those ions from impinging on the N-well regions 202, 204, and the STI regions 210, 212 are intended to prevent diffusion of ions into the N-well regions.

However, there is unintentional scattering of the ions from the photo resist, as shown in FIG. 2. The scattered ions change the Vₜ parameter of the transistor which would then form in the P-well region and, therefore, affect the circuit performance characteristic of the device. In accordance with one aspect of the present invention, the change in Vₜ as a function of the distance to the N-well 202 and/or 204 can be modeled as a cost function that can in turn be employed to manipulate the layout design to optimize the design.

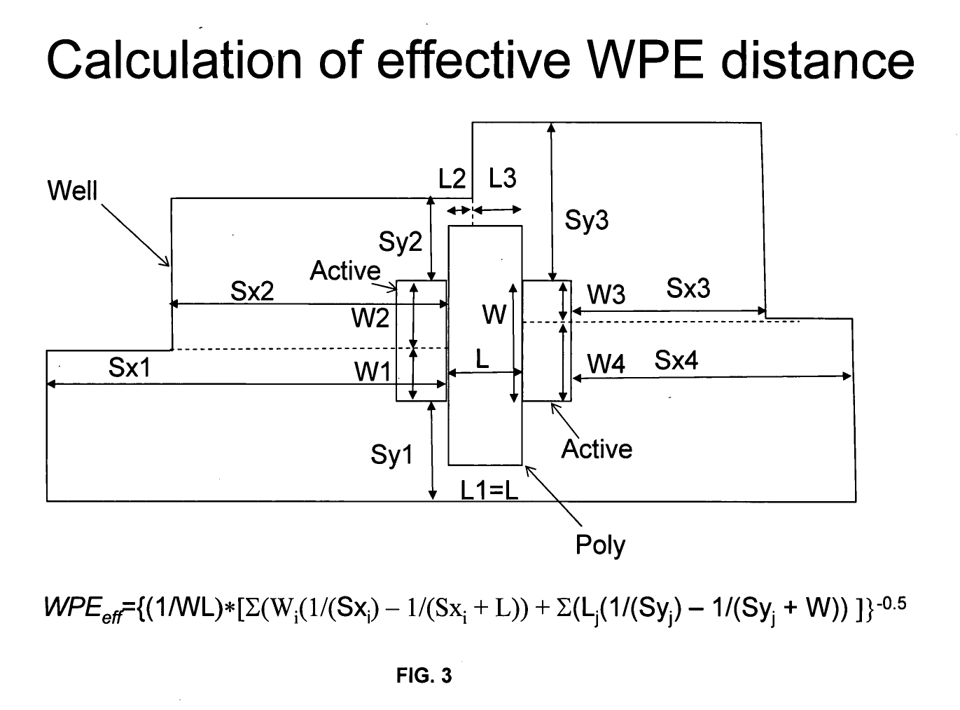

Accordingly, FIG. 3 is an example of dimensional characteristics for calculation of the effective well proximity effect (WPE) distance; including dimensions of parameters needed to calculate an effective well proximity effect (WPE) distance, WPE_{eff}, for generating a cost function that in turn can be employed to manipulate the layout design to optimize the device parameters. The effective well proximity effect distance is given by:

WPE_{eff}={(1 /WL)*[Σ(Wᵢ(1/(Sxᵢ)−1/(Sxᵢ+L))+Σ(Lⱼ(1/(Syⱼ)−1/(Syⱼ+W))]}^{-0.5} Equation 1

where the dimensions W, Wᵢ, L, Lⱼ, Sxᵢ, and Syⱼ are defined by distances between edges of polygons forming the structures of the device 200.

An example of a normalized cost function that can be generated for WPE_{eff} (normalized) is given by:

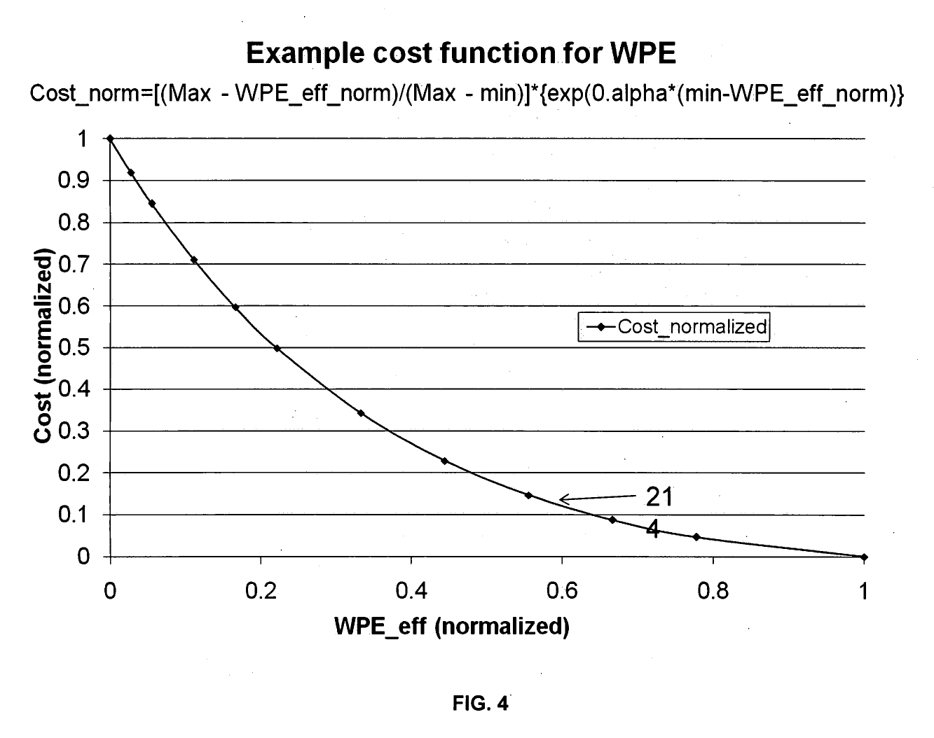

Cost_norm=[(Max−WPE_eff_norm)/(Max−Min)]*{exp(alpha*(Min−WPE_eff_norm)} Equation 2

where Max, Min, and alpha are given process specific parameters. The curve representing the behaviour of this cost function is shown by curve 214 in FIG. 4. The cost function can in turn be employed to manipulate the layout design to optimize the device threshold voltage for the device 200, which can then be used to optimize the desired circuit characteristics formed using such devices.

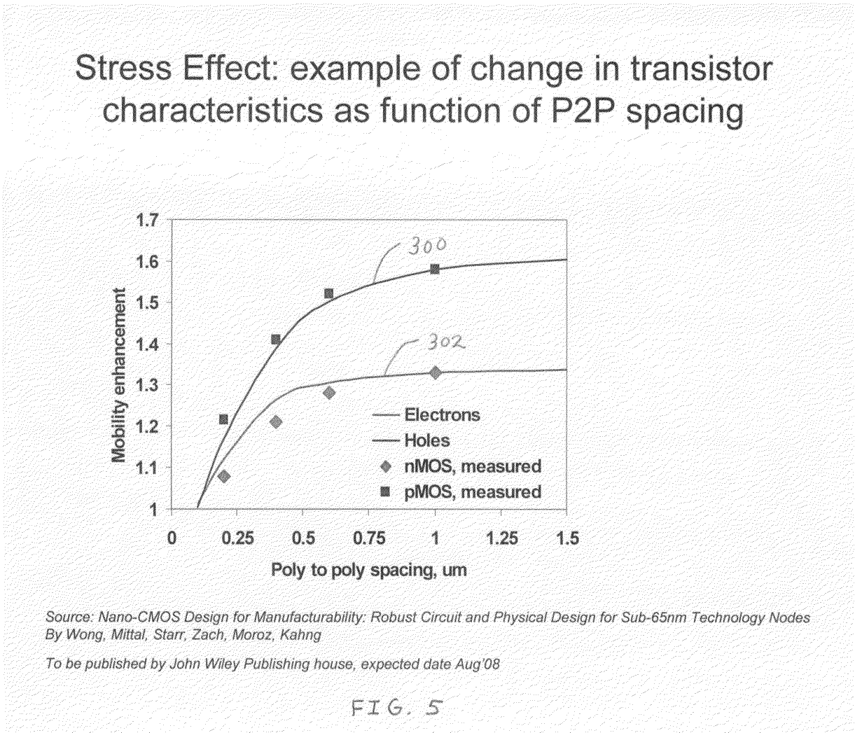

FIG. 5 shows the change in device parameters due to stress effects. Specifically, FIG. 5 shows an example of the change in mobility enhancement as a function of poly-to-poly (P2P) spacing for a PMOS transistor device (curve 300) and for an NMOS transistor device (curve 302). In accordance with another aspect of the present invention, a change in device parameters as a function of poly-to-poly (P2P) spacing is employed for generating a cost function that in turn can be employed to manipulate the layout design to optimize the device parameters.

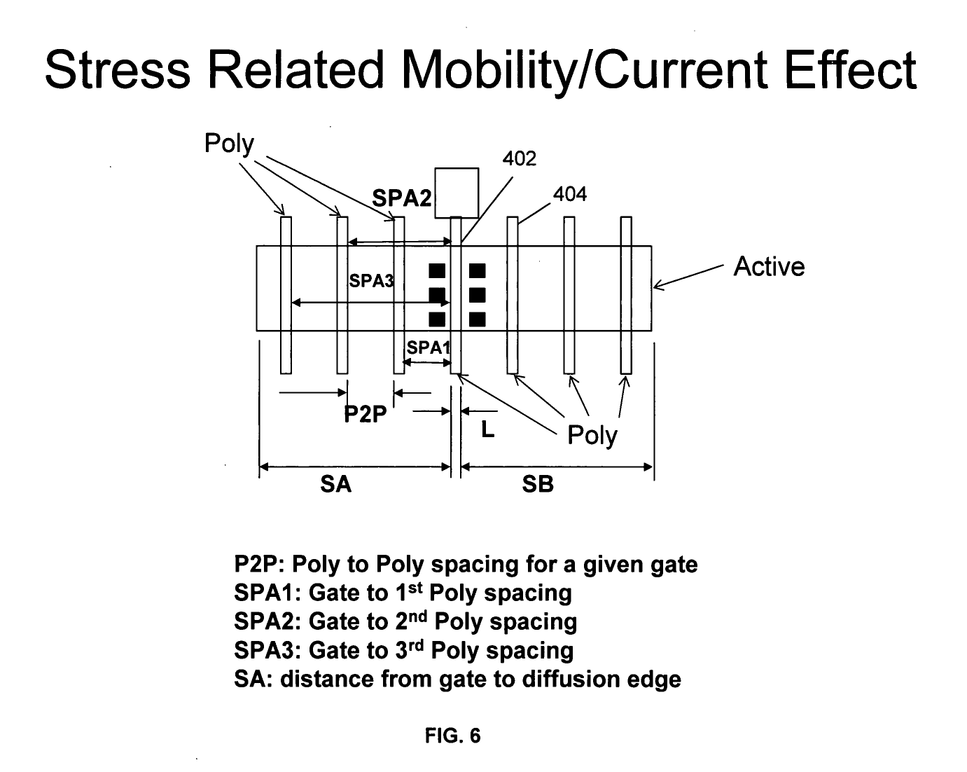

Accordingly, FIG. 6 is a schematic diagram of an N-type or P-type device, including dimensions that may be employed for generating a cost function that can in turn be employed to manipulate the layout design to optimize the device behaviour in accordance with the desired circuit behaviour. As shown in FIG. 6:

P2P is the poly-to-poly spacing for a given gate;

SPA is the distance corresponding to the gate to first poly spacing;

SPA2 is the distance corresponding to the gate to second poly spacing;

SPA3 is the distance corresponding to the gate to third poly spacing; and

SA and SB are the distances from the gate to the respective diffusion edges.

A cost function can be generated for an NMOS device employing the dimensions shown in FIG. 6 that in turn can be employed to manipulate the layout design to optimize the device parameters. For example, a cost function for the stress effect due to gate to first poly spacing may be generated respecting the change in NMOS current, I_{d}, due to the aforementioned stress effect, and is given by:

CF(x)=ax̂2+bx+c Equation 3

where x=SAᵢ and a, b, and c are given process specific parameters.

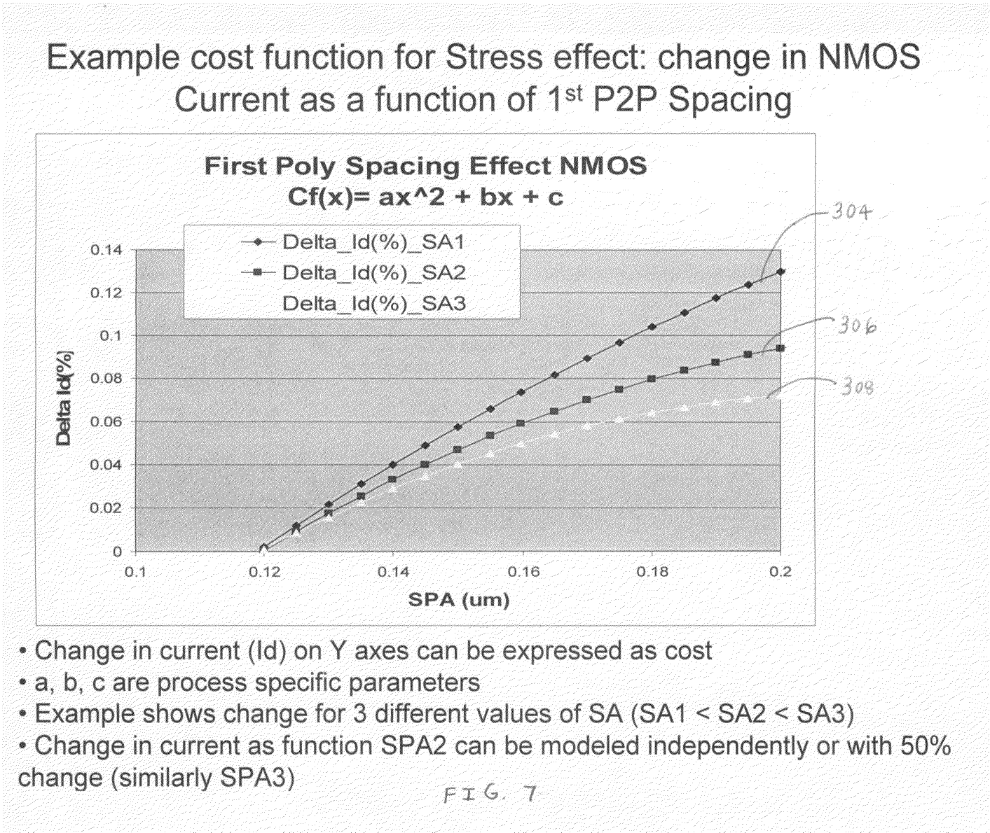

FIG. 7 shows the exemplary cost function for the stress effect due to change in SPA (gate to first poly spacing) changing the device current. The change in current is shown for three values of SA (distance of gate to diffusion edge). The curve 304 shows the change in I_{d} as a function of SPA for the first P2P spacing, SA1. The curve 306 shows the change in I_{d} as a function of SPA for the second P2P spacing, SA2. The curve 308 shows the change in I_{d} as a function of SPA for the third P2P spacing, SA3.

Also, a cost function can be generated for a PMOS device employing the dimension SA or SB corresponding to the distance between the gate of the device and one of the diffusion edges shown in FIG. 6 that in turn can be employed to manipulate the layout design to optimize the device parameters for the desired circuit performance characteristics. For example, a cost function for the stress effect due to the gate to diffusion edge spacing may be generated based on the change in PMOS current, I_{d}, as a function of the distance from the gate to the diffusion edge given by:

DeltaI_{d}(%)=100*((1/x̂n₁)−(1/x₀̂n₁))̂m₁ Equation 4

where n₁, m₁, and x₀ are process specific parameters and x=(SA+L).

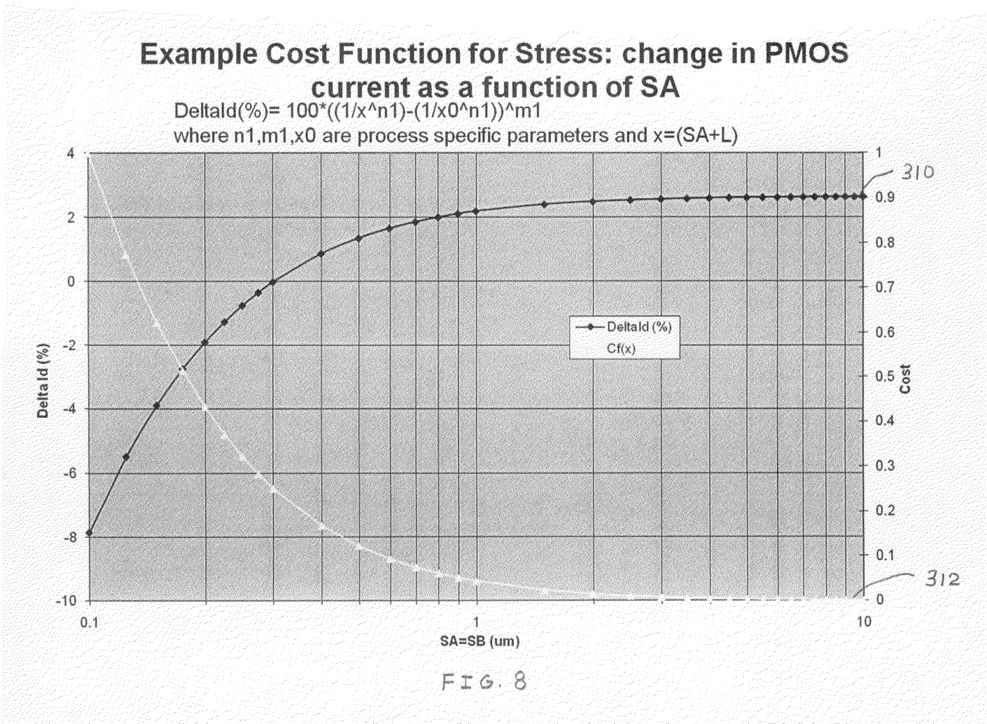

FIG. 8 shows a curve 310 for DeltaI_{d}(%) and a curve 312 for the exemplary cost function for the stress effect due to change in I_{d} as a function of the gate to diffusion edge spacing (for the case of SA=SB).

Referring again to FIG. 6, adjacent polygon elements can be used to specify a layout detail such as gate 402 and poly line 404. Initially, the layout detail is input in memory, specifically, the polygons corresponding to structures forming an integrated circuit layout are stored by their coordinates. Generally, this is done by storing geometrical details such as the corners and edges of the polygons.

The circuit performance characteristics can be modified by moving the edges of the polygons forming the layout. Edge movement can have a cost associated with it, and all of the costs can be aggregated to form an integral performance number. Since the dimensions are a property of both the input layout, and of perturbations to this layout, a cost function, for example, that of Equation 3, is able to predict the integral performance number. Hence, in order to optimize the layout design, the integral performance number assesses not only the quality of the design before optimization, but also assesses the quality of perturbations made to that design.

The co-pending international application number PCT/NL2007/050312 filed Jun. 27, 2007 entitled METHOD FOR OPTIMIZING AN INTEGRATED CIRCUIT PHYSICAL LAYOUT discloses usage of cost functions and all the associated mathematical/computational framework to optimize layout for the goals of reducing critical area or following recommended rules or enhancing defect related yield. The same mathematical/computational framework can be used to optimize circuit performance characteristics.

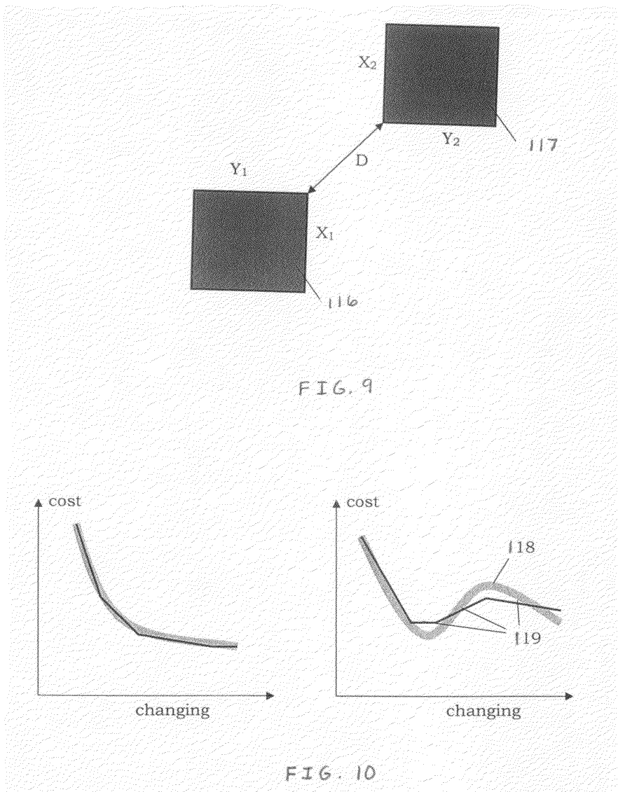

FIG. 9 is an illustration of an exemplary layout detail showing the effect of a layout perturbation for two neighbouring squares in a layout detail. Here, as in FIG. 6 adjacent polygon elements are constitute a portion of a layout detail of an IC. Accordingly, this layout detail is input in memory, wherein the polygon elements are stored by their edge and corner coordinates. Here, a first square 416 has edge coordinates X1 and Y1, and close thereto at distance D, another square 417, has edge coordinates X2 and Y2. A cost function relating the parametric yield depends on the distance D between the adjacent squares 416 and 417. Accordingly, the cost function would depend on D. However, D is dependent on the edge coordinates X1, X2, Y1, and Y2. So a four-dimensional function CF(X1, X2, Y1, Y2) is related to the parametric yield. Although in general cost functions may use any number of dimensions, for processing optimization a simplification can be made in the cost function. In accordance with a preferred embodiment of the present invention, the cost function uses only one dimension and is made piecewise linear, to be explained below. The argument of the cost function can be calculated from edge and corner positions in the layout using any type of linear expression. For example, in the layout of FIG. 9 a first approximation of distance D may be expressed as

D=0.5*√2*(−X1+X2−Y1+Y2) Equation 5

The linear expression to calculate D may be obtained by determining the direction of steepest decent of the multi-dimensional cost function. In most cases this expression for D is a simple distance (width or spacing) between two edges of a polygon.

An integral performance number for this layout is therefore provided by a cost function, which gives an estimated parametric yield as a simple aggregated number. To assist a user or an automatic optimization tool in optimizing the layout, the initial circuit layout is perturbed to evaluate a perturbed integral performance number of said perturbed layout; and layout perturbations are selected that optimize the integral performance number. Thus, in the present example, this amounts to finding a layout that has minimal total cost. Where in the example in FIG. 9 only a single layout detail is taken into account for the cost function, generally, in a cost function, details of many layout details are taken into account to arrive at a total aggregated performance number.

Thus, generally, this amounts to trading off an improvement of cost for one aspect to some smaller deterioration of cost for another. For this purpose, in one aspect of the present invention, the cost function is able to predict what happens to a changing layout; or in other words: a cost function is not a single number for a given layout, but a true function that can be evaluated as the layout changes or as the change in layout is predicted. As will be apparent to persons skilled in the art, calculation of such change is preferably implemented in an efficient way in terms of computer runtime.

According to an aspect of the present invention, optimization is done by changing the entire circuit layout, which implies changing local patterns and changing the assessed integral performance number. These numbers may be any combination of quality of the layout relative to different parametric yield mechanisms as well as integral performance numbers for a single parametric yield mechanism but at varying positions in the layout. Various embodiments of the present invention separate assessing these integral performance numbers from the actual optimization.

Assessment of the (unapproximated) integral performance number can be very computationally expensive (e.g., because it involves circuit simulation), making the global layout optimization infeasible. Localized assessment of the integral performance number can be tuned to the parametric yield mechanism at hand, and is computationally more efficient.

The actual optimization does work on the full circuit layout, for instance, by using polygon edge coordinates as independent variables. Since these are shared in the local performance numbers, the total performance number can be used for trade off between various parametric yield mechanisms. In accordance with the present invention, it is not relevant how the actual global optimization is done; the concern is how to prepare cost functions for proper trade off, and proper computation. Actual optimization can, for instance, be done by linear programming (if the cost functions are convex and piecewise linear), integer linear programming (if cost functions are piecewise linear but not convex), genetic algorithms, or simulated annealing (if cost functions are ill-shaped), etc.

FIG. 10 shows how the cost functions, which can have complicated shapes, are provided using linear approximations. During actual optimization, an optimization program uses a piecewise linear (PWL) model for the total cost of the layout. This PWL model is chosen as a compromise between good optimization runtime, and modeling flexibility and modeling accuracy. The aggregated cost function, for instance, by adding local cost functions, will be a PWL function too.

Accordingly, FIG. 10 shows examples of PWL functions. Also, FIG. 10 shows a curved line 118 indicating the true cost for a layout and an approximating set of line pieces 119 generated by the optimization program.

Some constraints apply to the cost functions and PWL versions thereof: for proper optimization (and also to reflect the physical reality) the values of cost functions preferably do not change when the total layout pattern is shifted in an x or y direction.

Further, preferably, the slope of the segment that extends to infinity (to the right in the graphs) must be zero. This also reflects physical reality: when objects of a layout are spaced far apart, they will not influence each other, so changing their relative position will not change cost.

Preferably, the cost for infinity is zero. This is not a real limitation since all optimization will be relative to other cost values, so adding a constant to the cost does not change the optimum.

Furthermore, not only the optimum analysis of these aspects may be of interest, but also robustness analysis of the selected optima. The latter aspect may include higher order differential analysis of the cost functions.

The skilled artisan will appreciate that, in the context of this description, the use of the term polygons, throughout the description, refer to entities in the forms of polygons, used to define physical entities on a substrate, that in combination provide and define the functioning of a (micro) electric circuit. In addition, piecewise linear (PWL) functions may be characterized as a set of linear functions, each of which is valid between fixed boundaries, and wherein the boundaries are annexed to provide a continuous (in the standard mathematical meaning) or almost continuous function over an entire region formed by said annexed boundaries. The terms “perturbing”, “perturbation,” etc. are used in their standard mathematical meaning but also may concern small variations, in particular, in the layout geometry of a layout to be analyzed, generated automatically or manually. The PWL functions can be used to approximate, up to a predefined criterion, a non-linear cost function.

While specific embodiments of the present invention have been described above, it will be appreciated that the invention may be practiced otherwise than as described. In particular, the descriptions above are intended to be illustrative, not limiting. Thus, it will be apparent to one skilled in the art that modifications may be made to the embodiments of the present invention as described without departing from the scope of the claims set out below.

What is claimed is:

1. A method for optimizing a global integrated circuit layout comprised of a number of polygons having a predetermined geometrical relation relative to each other, comprising:
providing an initial global integrated circuit layout;
assessing associated circuit performance characteristics, each as a cost function of at least one device or circuit performance parameter of a local geometrical pattern of shapes in said initial circuit layout determinative of said associated circuit performance characteristics;
aggregating cost functions of said associated circuit performance characteristics to derive an integral performance number associated to said initial global circuit layout;
perturbing said integral performance number by varying said global circuit layout; and
selecting perturbations that optimize the integral performance number, so as to optimize said global circuit layout.

2. A method according to claim 1, wherein said integral performance number represents a predicted electrical circuit performance value.

3. A method according to claim 2, wherein said predicted electrical circuit performance is related to reducing power or improving speed or reducing design guardband or variability or improving device modeling accuracy or increasing parametric yield.

4. A method according to claim 1, wherein said circuit performance parameter is dependent on a P-N transistor size ratio associated with geometrical characteristics of said circuit layout.

5. A method according to claim 1, wherein said circuit performance parameter is dependent upon device parameters related to physical effects comprising well proximity effect (WPE) or stress/strain engineering associated with the geometrical characteristics of said circuit layout.

6. A method according to claim 1, wherein said cost function is provided by evaluating the associated device or circuit performance parameter on perturbations to the local pattern of shapes, so as to assess cost function values of said associated circuit performance characteristics.

7. A method according to claim 1, wherein a global integrated circuit layout is provided by storing corner and edge coordinates of polygons representing the shapes of a local pattern; and wherein said cost function is provided as linearly dependent on said corner and edge coordinates.

8. A method according to claim 7, wherein a linear dependency on said corner and edge coordinates is provided by determining a direction of steepest descent of a multidimensional cost function associated with circuit performance characteristics.

9. A method according to claim 7, wherein said cost function is provided as a piecewise linear function.

10. A method according to claim 7, wherein said cost function is provided as a quadratic function.

11. A method according to claim 7, wherein said circuit performance parameter is dependent on physical effects comprising WPE or stress/strain engineering associated with geometrical characteristics of said circuit layout.

12. A method according to claim 7, wherein said circuit performance parameter is dependent on stress/strain engineering due to contact etch stop layer (CESL) effect, poly to poly (P2P) spacing, stress relaxation due to contact configurations, dual etch stop layer (DESL), distance to shallow trench isolation (STI) edge, distance of poly to etch stop layer, or another physical effect that influences device or circuit performance parameters associated with geometrical characteristics of said layout.

13. A method according to claim 7, wherein said integral performance number is expressed as a function of predicted integrated circuit transistor parameters.

14. A method according to claim 1, wherein said global circuit layout is generated deterministically by a set of parameters, and wherein said perturbations are provided by perturbation of said parameters.

15. A method according to claim 1, wherein said global circuit layout is varied by varying the local patterns or cost functions.

16. A computer program adapted to be run on a programmable apparatus to optimize a global integrated circuit layout comprised of a number of polygons having a predetermined geometrical relation relative to each other, the computer program having program code portions, comprising:
code to provide an initial global integrated circuit layout;
code to assess associated circuit performance characteristics, each as a cost function of at least one device or circuit performance parameter of a local geometrical pattern of shapes in said initial circuit layout determinative of said associated circuit performance characteristics;
code to aggregate cost functions of said associated circuit performance characteristics to derive an integral performance number associated to said initial global circuit layout;
code to perturb said integral performance number by varying said global circuit layout; and
code to select perturbations that optimize the integral performance number, so as to optimize said global circuit layout.

17. A computer program according to claim 16, wherein said integral performance number represents a predicted electrical circuit performance value.

18. A computer program according to claim 17, wherein said predicted electrical circuit performance is related to reducing power or improving speed or reducing design guardband or variability or improving device modeling accuracy or increasing parametric yield.

19. A computer program according to claim 16, wherein said circuit performance parameter is dependent on a P-N transistor size ratio associated with geometrical characteristics of said circuit layout.

20. A computer program according to claim 16, wherein said circuit performance parameter is dependent upon device parameters related to physical effects comprising well proximity effect (WPE) or stress/strain engineering associated with the geometrical characteristics of said circuit layout.

21. A computer program according to claim 16, wherein said cost function is provided by evaluating the associated device or circuit performance parameter on perturbations to the local pattern of shapes, so as to assess cost function values of said associated circuit performance characteristics.

22. A computer program according to claim 16, wherein a global integrated circuit layout is provided by storing corner and edge coordinates of polygons representing the shapes of a local pattern; and wherein said cost function is provided as linearly dependent on said corner and edge coordinates.

23. A computer program according to claim 22, wherein a linear dependency on said corner and edge coordinates is provided by determining a direction of steepest descent of a multidimensional cost function associated with circuit performance characteristics.

24. A computer program according to claim 22, wherein said cost function is provided as a piecewise linear function.

25. A computer program according to claim 22, wherein said cost function is provided as a quadratic function.

26. A computer program according to claim 22, wherein said circuit performance parameter is dependent on physical effects comprising WPE or stress/strain engineering associated with geometrical characteristics of said circuit layout.

27. A computer program according to claim 22, wherein said circuit performance parameter is dependent on stress/strain engineering due to contact etch stop layer (CESL) effect, poly to poly (P2P) spacing, stress relaxation due to contact configurations, dual etch stop layer (DESL), distance to shallow trench isolation (STI) edge, distance of poly to etch stop layer, or another physical effect that influences device or circuit performance parameters associated with geometrical characteristics of said layout.

28. A computer program according to claim 22, wherein said integral performance number is expressed as a function of predicted integrated circuit transistor parameters.

29. A computer program according to claim 16, wherein said global circuit layout is generated deterministically by a set of parameters, and wherein said perturbations are provided by perturbation of said parameters.

30. A computer program according to claim 16, wherein said global circuit layout is varied by varying the local patterns or cost functions.

31. A system for optimizing an integrated circuit layout, comprising:
an input for receiving an initial global integrated circuit layout;
a processing circuit arranged to:
assess a function of said initial circuit layout, to derive an integral performance number associated to said initial circuit layout as an aggregated function of associated circuit performance characteristics, each as a function of physical characteristics of local patterns of shapes;
perturb said integral performance number by varying said global circuit layout; and
select perturbations that optimize the integral performance number; and
an output for outputting said selected perturbations.

32. A method, comprising the steps of:
reading in and storing an initial global integrated circuit layout and geometrical relationships between edges and corners; and
relating said geometrical relationships to circuit performance characteristics or behavior through cost functions, wherein the cost functions are:
a. directly a bridge between a circuit performance parameter and the geometrical shapes, wherein circuit performance characteristics are derived from the circuit parameter; or
b. based on physical effects which influence characteristics of an active or passive semiconductor device as a function of the geometrical shapes and distances which comprise the layout of the device and associated immediate neighborhood, wherein the cost functions which are deterministic of a change in device behavior as a function of layout distances are further used to achieve desired circuit performance characteristics that are a function of device parameters.

33. A method according to claim 32, wherein the cost functions are directly a bridge between a circuit parameter and the geometrical shapes, further comprising the step of using the cost functions to derive an integral performance number related to or determinative of circuit behavior.

34. A method according to claim 32, wherein the cost functions are directly a bridge between a circuit parameter and the geometrical shapes, further comprising the step of aggregating cost functions of said associated circuit performance characteristics to derive an integral performance number associated to said initial global circuit layout.

35. A method according to claim 32, wherein the cost functions are directly a bridge between a circuit parameter and the geometrical shapes, further comprising the step of perturbing said integral performance number by varying said global circuit layout.

36. A method according to claim 32, wherein the cost functions are directly a bridge between a circuit parameter and the geometrical shapes, wherein the bridge between the circuit parameter and the geometrical shapes is dependent on a P-N ratio.

37. A method according to claim 32, wherein the cost functions are based on physical effects, further comprising the step of using the cost functions to derive an integral performance number related to or determinative of circuit behavior.

38. A method according to claim 32, wherein the cost functions are based on physical effects, further comprising the step of aggregating cost functions of said associated circuit performance characteristics to derive an integral performance number associated to said initial global circuit layout.

39. A method according to claim 32, wherein the cost functions are based on physical effects, further comprising the step of perturbing said integral performance number by varying said global circuit layout.

40. A computer program adapted to be run on a programmable apparatus to optimize a global integrated circuit layout comprised of a number of polygons having a predetermined geometrical relation relative to each other, the computer program having program code portions, comprising:
code to read in and store an initial global integrated circuit layout and geometrical relationships between edges and corners; and
code to relate said geometrical relationships to circuit performance characteristics or behavior through cost functions, wherein the cost functions are:
a. directly a bridge between a circuit performance parameter and the geometrical shapes, wherein circuit performance characteristics are derived from the circuit parameter; or
c. based on physical effects which influence characteristics of an active or passive semiconductor device as a function of the geometrical shapes and distances which comprise the layout of the device and associated immediate neighborhood, wherein the cost functions which are deterministic of a change in device behavior as a function of layout distances are further used to achieve desired circuit performance characteristics that are a function of device parameters.

41. A computer program according to claim 40, wherein the cost functions are directly a bridge between a circuit parameter and the geometrical shapes, further comprising code to use the cost functions to derive an integral performance number related to or determinative of circuit behavior.

42. A computer program according to claim 40, wherein the cost functions are directly a bridge between a circuit parameter and the geometrical shapes, further comprising code to aggregate cost functions of said associated circuit performance characteristics to derive an integral performance number associated to said initial global circuit layout.

43. A computer program according to claim 40, wherein the cost functions are directly a bridge between a circuit parameter and the geometrical shapes, further comprising code to perturb said integral performance number by varying said global circuit layout.

44. A computer program according to claim 40, wherein the cost functions are directly a bridge between a circuit parameter and the geometrical shapes, wherein the bridge between the circuit parameter and the geometrical shapes is dependent on a P-N ratio.

45. A computer program according to claim 40, wherein the cost functions are based on physical effects, further comprising code to use the cost functions to derive an integral performance number related to or determinative of circuit behavior.

46. A computer program according to claim 40, wherein the cost functions are based on physical effects, further comprising code to aggregate cost functions of said associated circuit performance characteristics to derive an integral performance number associated to said initial global circuit layout.

47. A computer program according to claim 40, wherein the cost functions are based on physical effects, further comprising code to perturb said integral performance number by varying said global circuit layout.
